(19) United States
(12) Patent Application Publication
(10) Pub. No.: US 2002/0118106 A1
(43) Pub. Date: Aug. 29, 2002

(54) Food safety discernment device

(76) Inventor: Eric Walter Brenn, Aliso Viejo, CA (US)

Correspondence Address: Curt Harrington, Suite 250, 6300 State University Drive, Long Beach, CA, 90815, US

(21) Appl. No.: 09/792,491

(22) Filed: Feb. 23, 2001

(51) Int. Cl. G08B 1/00

(52) U.S. Cl. 340/531; 340/540

(57) ABSTRACT

The apparatus and method solves this aforementioned problems by providing an instantly recognizable indication not only of the status of the equipment, but also the level or severity of the problem so that an immediate decision can be made to (1) continue operations until the end of the operation period, or (2) continue operations in peak time until after a roll off in the peak activity, or (3) cease utilization of the equipment until the problem can be addressed or if the equipment is of such primary importance, to cease operation until the equipment can be repaired. Colors indicators are illustrated as one possible realization of the indicator embodiments.

### FIELD OF THE INVENTION

This application relates generally to novel and improved ways to indicate a food safety issue in equipment which has a high likelihood of being correctly dealt with than current methods of indication.

### BACKGROUND OF THE INVENTION

In equipment that is currently commercially available on the market today are either so overly simple or so overly complex as to be ineffective. At the simple end of the scale, equipment may have simple lights which illuminate to indicate an equipment failure or that something is wrong with the equipment. The operators who typically receive this signal are usually in the middle of food preparation and service. A simple alarm light does not indicate the severity or criticality of the failure, and depending upon past experience, the operators are likely to either ignore the warning, or stop everything that they are doing and call for an emergency visit by the equipment repairman.

At the other end of the spectrum are code number displays which provide a vast array of specific information in a code, typically letters and numbers, which can be decoded using a diagnostic manual. This method is effective when errors occur during off hours, as during off hours time, management or operators will have the time to read, study, and understand the problem, discern whether the problem is critical or long term, and then determine the best action to take. This sort of system is disastrous when it occurs during peak hours, as it is not immediately apparent as to its criticality. Like the simple light, an error code message is likely to either create a work stoppage or simply be ignored. Both types of indicator are either indications of errors that can go unnoticed, are too confusing, or are panicked over without reason. There does not seem to be a system on the equipment to indicate if the failure causes a food safety concern, is critical, non-critical or that everything in the equipment is working within the normal range.

This problem exists, notwithstanding the ability or inability of the device to assist in its diagnosis. Further, most types of equipment having a pre-set group of diagnostics are not found in the food industry, but are in machines which are expected to have exactly the same set of operating parameters all the time. Copiers are one example, and the inputs and operating conditions are generally the same or close enough that the conditions are pre-set at the factory. This is in stark contrast to the food industry where different foods, and indeed different specifications within a common type of food will tend toward the ability and necessity for the operators or management to set their criticality levels for each piece of equipment, and for each type of food utilized. Further, and even beyond the ability to set for different sorts of foods, and where final product quality is to be very high, the limits of “normal” operation are likely to be much tighter than in other areas where the quality may be relaxed.

What is therefore needed is a sensing and indicator system which gives an instant visual indication of both the existence of and severity or criticality or both of equipment errors. The error levels should be customizable by management to respond both to the criticality of environmental standards for different types of foods, as well as quality standards, especially where such quality standards are necessary to maintain high output quality.

### SUMMARY OF THE INVENTION

The apparatus and method solves this aforementioned problems by providing an instantly recognizable indication not only of the status of the equipment, but also the level or severity of the problem so that an immediate decision can be made to (1) continue operations until the end of the operation period, or (2) continue operations in peak time until after a roll off in the peak activity, or (3) cease utilization of the equipment until the problem can be addressed or if the equipment is of such primary importance, to cease operation until the equipment can be repaired. Further, the system can allow communication of a with a central station, which can be valuable in notifying more responsible persons in the hierarchy, as well as repair technicians. Furthermore, the system can record problems with the equipment to thus give the public a further assurance of high quality by noting that breaches in quality control can be tracked

This system allows the operator to instantly look with his own eyes or remotely at a piece of equipment and see if the problem has made the equipment unsafe and they have to deal with immediately or it can be focused on at a later time. This is a valuable tool for any piece of food equipment and can have a phenomenal impact on national food safety that is a concern for the public. Without this type of invention food safety issues can easily go unnoticed and if the equipment is not working correctly, it can have devastating results and even cause death of operators in certain circumstances.

The process and apparatus also provides one simple way to easily educate the operators and management of food safety issues relating the equipment not running correctly. It is simple, highly visible, and a low cost method to improve food safety and the safety of equipment. What makes this invention truly novel is that it allows the equipment to be preprogrammed to sense or calculate when food safety fault conditions occur and to then differentiate between non-food safety and food safety issues, and then communicate those issues clearly visually, and if possible, electronically to a remote location.

The recommended deployment of an indicator system is that it have at least one indicator. More indicators can be used and can be combined into a single location to indicate a food safety conditions. One recommended setup may be, for example, a blinking red light for food safety, a steady red light for a condition which is about to go into a food safety default level, and a yellow for non-food safety condition, and a green light for normal operations. The warning indicators can be lights, flashing lights, moving signs, flashers, digital representations, different levels of audible alarms, special types or mechanisms on the equipment to indicate a food safety issue, about to going to be a food unsafe state, or a non-food safety problem and can be combined with different types of flashing, sounds, voice making devices, or lighted up wording.

The focus provides simple discernable indicator of two main danger conditions: The equipment is about to provide unsafe servings of food and the equipment is providing unsafe servings of food. This information could also be sent via Email, dial up connection or other types of electronic communications to inform individuals who are in authority to respond to the unsafe condition. Many times those in authority and responsible for the equipment are not on the same site as the equipment and they could be paged or remotely monitor the unsafe situation.

The process and apparatus herein, if utilized to promulgate into a full set of standards for all types of equipment and all types of food, yield a multi-dimensional set of limits for food and equipment type combinations.

There are cost savings to society as well. These standards, if practiced, could save people thousands of visits to the hospital which are otherwise not necessary if the restaurants knew their equipment was unsafe from which to serve food. If the food and equipment limits are standardized within a governmental jurisdiction these occurrences could also be directly or indirectly monitored by a governing body, health department, or some kind of public or private organization.

### BRIEF DESCRIPTION OF THE DRAWINGS

The invention, its configuration, construction, and operation will be best further described in the following detailed description, taken in conjunction with the accompanying drawings in which:

FIG. 1 is a generalized flow diagram of how the apparatus and process differentiates between food safety, about to be food safety, non-food safety, and normal operating conditions;

FIG. 2 is a simplified block diagram illustrating how a computer can be connected to sensors and to a food safety panel; and

FIG. 2 is a schematic drawing showing the indicator described on a piece of equipment with normal, non-critical error and normal operation indication, as well as an error code display.

### DETAILED DESCRIPTION OF THE PREFERRED EMBODIMENT

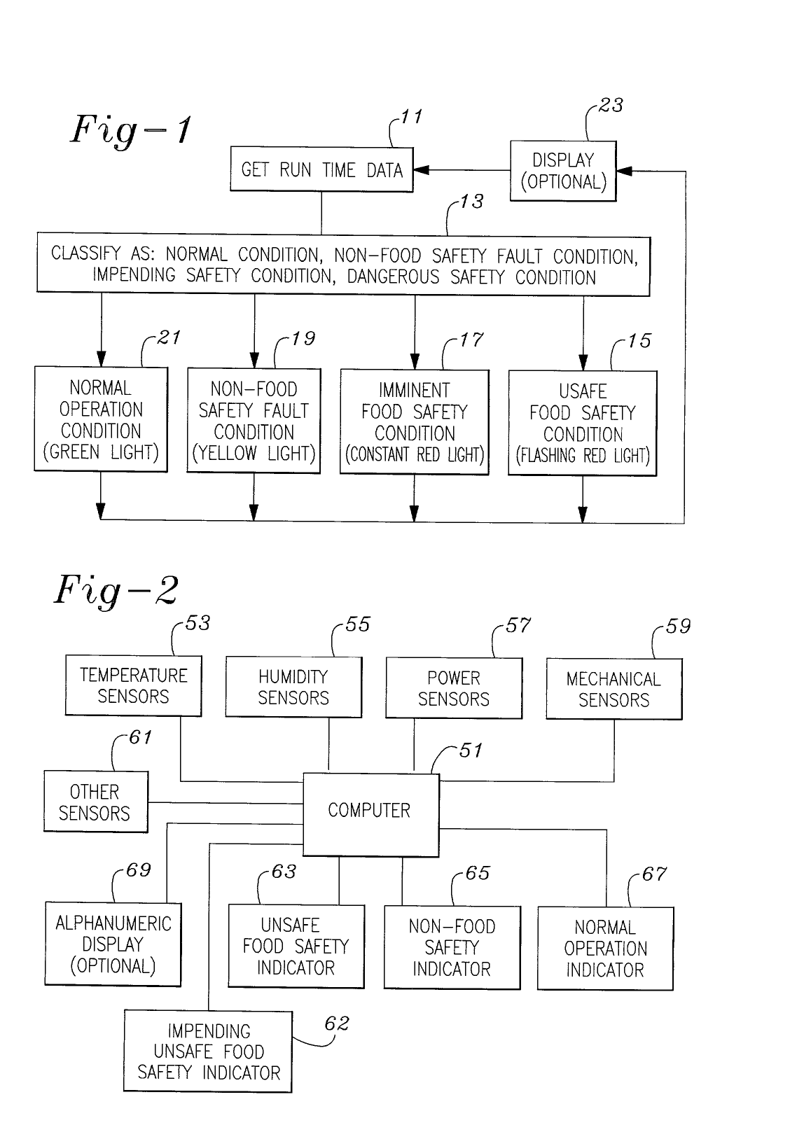

The description and operation of the food safety system apparatus and method of the present invention will be best described with reference to FIG. 1. An initial block 11 is at the top of the block and logic flow diagram of FIG. 1 and is entitled GET RUN TIME DATA block 11. This block can consist of a list of data acquisition tasks which may proceed in series or parallel and such collection activities may not necessarily occur each time that the logic loops through. The actual sensors for run time data will depend upon the particular piece of equipment, but may include temperature, humidity, fluid pressure, and the like, and may also extend to mechanical and electrical condition sensors such as door sensors, power consumption sensors, circulation fans or pumps, inlet and drain valves, and the like. In some cases an aspect of the equipment will be updated only every five minutes, while other aspects will actually be queried by the processor executing the statements in GET RUN TIME DATA block 11 as it goes through its logic flow path.

The logic from GET RUN TIME DATA block 11 extends to a CLASSIFY AS: NORMAL CONDITION, NON-FOOD SAFETY FAULT CONDITION, IMMINENT SAFETY CONDITION, DANGEROUS SAFETY CONDITION block 13. In CLASSIFY AS: NORMAL CONDITION, NON-FOOD SAFETY FAULT CONDITION, IMMINENT SAFETY CONDITION, DANGEROUS SAFETY CONDITION decision block 13 each and every measured aspect which was gathered or sensed in GET RUN TIME DATA block 11, are compared to a set of desired criteria associated with such aspect. Examples of the comparison for temperature may be as follows. Where 150° F. to 200° F. is the normal range, and where temperatures outside the 150° F. to 200° F. are considered an unsafe food condition, the temperature sets for IMMINENT food safety breach may be, for example an unacceptable movement toward either one of these limits. It may be a combination of closeness, such as coming slowly to 155° F., or it may be too rapid an acceleration of the temperature in the direction of 150° F., even from a starting point of 190° F. It may be a heuristic combination of several other factors and sensory inputs. A simple example of a one dimensional failure might be the discovery that an air movement fan had malfunctioned, and especially where it is known that the safe food temperature cannot be maintained without it. In that case, an imminent condition would be immediately established as a passage of the temperature into the unsafe condition is inevitable.

Other combinations of heuristic indicators which will produce the imminent unsafe food will depend upon the food item, and the item of equipment, and many are listed herein. The importance of the imminent condition is that management can be alerted before the food is wasted or before an unsafe condition of the food is allowed to develop. In real terms, the imminent indication will in many cases enable management to reset a breaker, change a fuse, or simply replace an electronic component and thus keep the equipment running at a point before it enters an unsafe condition. Beyond this, the unsafe condition indicator serves as a warning to management and food workers, that the food in the unit is unsafe and should be thrown out immediately, to stop operations with the unit of equipment until the problem is solved. Thus, the system described will save food cost, but more importantly it will save lives.

Continuing the example, if the assessed range found the temperature to be within the normal operating range, in the example from 150° F. to 200° F., and also where there were no nonfood safety problems, the logic flow would proceed to a NORMAL OPERATION CONDITION (GREEN LIGHT) block 15. The term “green light” is an option where a preferred flashing red, constant red, green and yellow light system is used, to indicate normal operations with a green light.

Continuing the example, if a non-food safety problem occurs in the equipment, and while the temperature for example was in the normal operating range, the logic flow would proceed to a NON-FOOD SAFETY FAULT CONDITION (YELLOW LIGHT) block 17. The term “yellow light” is an option where a preferred flashing red, constant red, yellow and green light system is used, to indicate normal operations with a green light.

Further continuing the example, if the assessed range found the temperature to be either heading outside the normal operating range, or having undergone a failure which is certain to eventually draw the equipment into an unsafe condition, even while presently not actually in an unsafe condition, and still within the normal safety condition range, in the example from 150° F. to 200° F., the logic flows to an IMMINENT SAFETY CONDITION (CONSTANT RED LIGHT) block 19. The term “constant red light” is an option where a possible flashing red, constant red, green and yellow light system is used, in this case to indicate an IMMINENT safety condition with a flashing red light.

Further completing the example, if the assessed range found the temperature to be beyond the imminent safety condition range and in the under 150° F. or over 200° F., for example the logic flows to an UNSAFE SAFETY CONDITION (FLASHING RED LIGHT) block 21. The term “flashing red light” is an option where a preferred flashing red, constant red, green and yellow light system is used, in this case to indicate an unsafe condition with a flashing red light.

Also from the blocks 15, 17, 19, and 21, the logic may optionally flow by a DISPLAY block 23, before the logic returns to the GET RUN TIME DATA block 11. As the system cycles, the DISPLAY block 23 may keep a running account of any of the problems discovered in block 13, as well as display one of a series of messages, including “normal” when the system is running normally. The logic then returns to the GET RUN TIME DATA block 11.

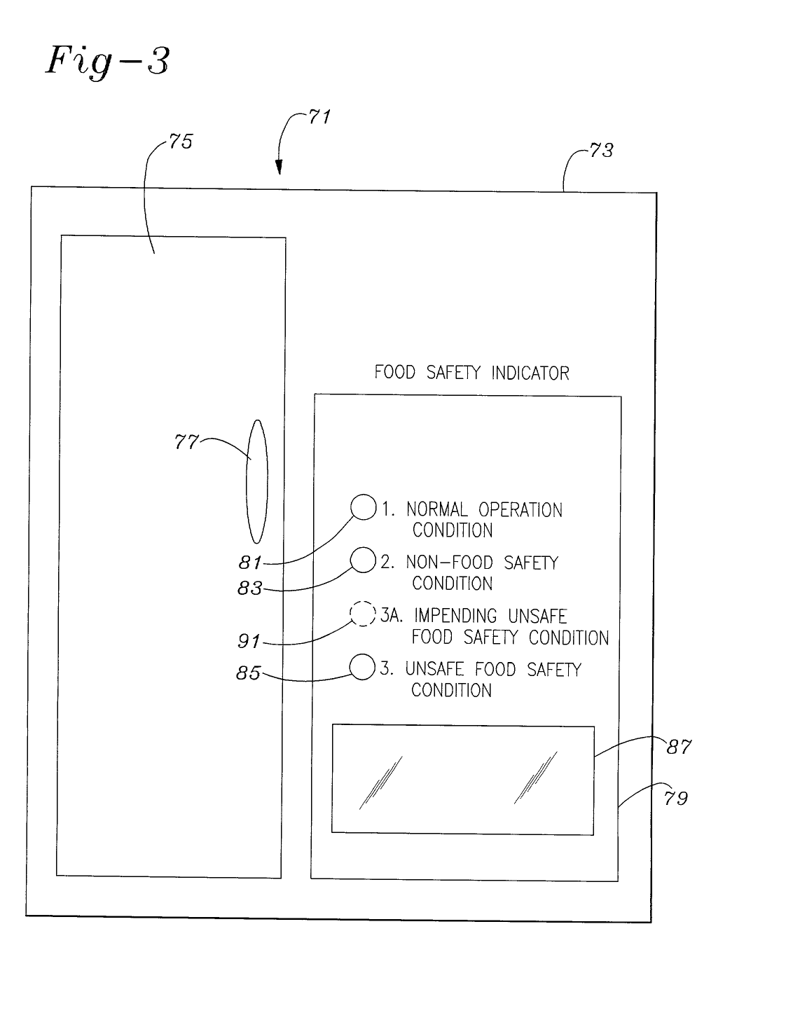

Referring to FIG. 2, a schematic layout of the system of the invention illustrates a computer 51 connected to temperature sensors 53, humidity sensors 55, power sensors 57, mechanical sensors 59, and other sensors 61. Computer 51 has a variety of displays which may include a single display with a readout. However, for purposes of understanding the logic and to specifically illustrate that separate commands and indications can be used to indicate the different states, computer 51 is connected to an impending unsafe food safety indicator 62, an unsafe food safety indicator 63, a non-food safety indicator 65, and a normal operation indicator 67.

Computer 51 may be, as is known in the art, connected to other computers as by hard wiring, by automatic dialing of a telephone line, or simply by constant connection to a computer web such as the world wide web also known as the Internet. Computer 51 is expected to keep a record of all the sensors and equipment operation inputs to which it is connected, as well as other computers it has notified. In addition, as further heuristics become known which either tighten or relax the condition or number of conditions which place such equipment into the imminent food safety condition, computer 51 can receive updates either by polling from a central location, or by having each of the computers 51 periodically communicate with a centralized information source, such as a central web page, for example.

Further, the computer 51 may also be in control of many of the pieces of equipment to allow an expanded role in food safety by enabling control response. Such response could include action to prolong the imminent unsafe food safety condition by causing other parts of the equipment to work harder to stave off the inevitable unsafe food safety condition. In other instances, the computer 51 may be enabled to prevent operation of the equipment altogether. Such prevention may be by locks, or disabling aspects of its operation. Where the computer 51 is the same computer which controls the equipment, a “smart” and nearly foolproof food safety distributed system can be had. Where the imminent condition can be prolonged, other decisions can be made about whether to shut down or repair, whether a repairman should be called, all with due regard to replacement part availability on site versus with a technician versus on order, technician location, level of expertise on site, and many more capabilities of the smart system described herein.

Now the indicators 62, 63, 65 and 67 can be any combination of audible, visual, and control reacting devices. Control reacting devices may include a modem, Internet messaging center, web page accessing software and hardware, and the like. The use of lights is permitted and encouraged, in addition to other audible, visual, and control reacting devices. One simple possibility involves the use of a flashing red light for impending unsafe food safety indicator 62, a solid red light for unsafe food indicator 63, a yellow light for non-food safety indicator 65, and a green light for normal operations indicator 67. An optional alphanumeric display 69 is also connected to the computer 51. Further, where a lighting control is provided which can be solid red and flashing red, the indicators 62 and 63 can be combined such that a light flashes during the impending condition and solid red for an actual unsafe food condition.

Referring to FIG. 3, a unit of equipment 71 has a housing 73 is fitted with a door 75 having a handle 77. Unit of equipment 71 may be of any type, as for example only a freezer, refrigerator or heated box and many, many other devices. Adjacent the door 75 is a FOOD SAFETY INDICATOR panel or display 79. The display 79 has a series of three lights, possibly including a red light 81, a yellow light 83 and a green light 85. It is understood that modern semiconductor technology will allow all three colors to be integrated into a single area, perhaps a small circle which can glow green, red or yellow as needed and that three separate lights are equivalent to one light structure or illumination area having the ability to show three colors. Also seen is an optional alphanumeric display window 87 for showing preferably plain text writing of the status of the equipment 71.

As has been stated, one preferable sequence for three lights includes a first color light, such as a green light for a normal operation condition, a second color light, such as a yellow or amber light for a non-food safety condition, and a third light, possibly a red light which flashes for an impending unsafe food condition. A further option is shown as a light 91 labeled 3A, impending unsafe food safety condition, where the flashing option is not desired.

With the background given, including the process as in FIG. 1, the apparatus as seen in FIGS. 2 & 3, a set of likely conditions are now set forth. These conditions are expected to be more finely tuned, as previously stated, based upon the specific type of equipment and specific type or types of food present. These include:

A freezer, hot cabinet, cold cabinet, refrigerator door, such as equipment 71 door 75 has been left open and the temperatures have been changing so that even at full power the system will not be able to recover unless user intervention is applied.

On a hot table or a cold table a set of pan inserts have been removed and the temperatures have been changing that even at full power the system will not be able to recover unless user intervention is applied.

An equipment 71 having hot or cold drawers are pulled out too long or have been removed and the temperatures have been changing that even at full power the system will not be able to recover unless user intervention is applied.

A set of circulation fans or pumps have failed causing uneven heating and cooling in an equipment 71.

An inlet valve in food equipment 71 is stuck off not allowing heating or cooling to take place.

An inlet valve or bypass is stuck on dissipating the heating or cooling that is taking place to go down the overflow and a unit cannot recover.

A drain valve is stuck on and not allowing the fluid or gas in an element of equipment 71 to stay in the designated area for heating and cooling.

In an equipment 71 there are more heating sources (elements, gas, etc) than the amount needed for the unit's recovery have failed.

Cooling/heating fluid or gas is not at the correct pressure to keep the a unit of equipment 71 running.

A compressor for a unit of equipment 71 is overheating.

In a unit of equipment 71, there is not enough air flow across the coils to keep cold or hot or to dissipate the heat or cold.

The temperature probe of a unit of equipment 71 is out of calibration, broken or shorted.

The “on” times a unit of equipment 71 do not match up with the feedback from the sensors.

The systems heating or cooling sources of a unit of equipment 71 are stuck in the “on” position and cannot be turned off.

The breakers in a unit of equipment 71 have been turned off or there has been a loss in electrical power.

Essential probes in a unit of equipment 71 are in need cleaning causing uncertainty of food safety.

A valve in a unit of equipment 71 has broken causing constant heating or cooling in the system.

A fluid has been detected in the control box or on the circuitry or other critical places in a unit of equipment 71 where it should not be present.

An air or fluid leak in the system of a unit of equipment 71 has been detected and system cannot recover.

Not enough air flow has been detected in a unit of equipment 71.

The amount of current, in a unit of equipment 71, used by the compressor, elements, valves, fans, and motors does not match what has been called for in order to recover.

No fluid flow has been detected in an operating system of a unit of equipment 71.

A filtration system/method in a unit of equipment 71 is about to or has failed.

A system in a unit of equipment 71 has or is about to shut itself down for safety reasons.

A system in one or more units of equipment 71 has or is about to shut itself down to protect itself from damage.

A system in a unit of equipment 71 has a critical gas or fluid leak.

A unit of equipment 71 system's humidity is dropping below/above a critical point.

In a unit of equipment 71, a systems temperature is dropping below/above critical point.

A system of a unit of equipment 71 has too much or not enough pressure.

A system of a unit of equipment 71 has too much or too little fluid, oil or gas.

A system of a unit of equipment 71 is changing critical values too frequently causing uncertainty of food safety.

System PH levels of a unit of equipment 71 are in the critical regions.

In a system of a unit of equipment 71 contamination reaches a part per million count which is in the critical region.

In a unit of equipment 71, someone has remotely or locally tampered with the system settings or set points causing uncertainty of food safety.

A systems critical sensors in a unit of equipment 71 are out of calibration, shorted or open causing uncertainty of food safety.

Critical Pumps, fans, motors, solenoids, valves, heaters, coolers of a unit of equipment 71 are stuck on or off.

Individual specific parameter setting in the above list are expected to be more greatly specified, again depending upon the type and types of food in a particular unit of equipment 71, as well as the different types of unit of equipment 71.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. An automated system for giving an instant status indication for food containment equipment comprising:
threshold means, for connection to at least one sensor of a food containment equipment unit, having a pre-set limit for characterizing said condition into a normal operation condition, a non-food safety condition, an imminent unsafe food condition and an unsafe food safety condition; and
an indicator connected to said threshold means for indicating instantly the condition of said food containment equipment, including a first indicator based upon at least one of said imminent food safety condition and said unsafe food safety condition, and a second indicator based upon at least one of said normal operation condition and said non-food safety condition.

2. The automated system for giving an instant status indication for food containment equipment as recited in claim 1 wherein at least one of said first and said second indicators is a color indicator.

3. The automated system for giving an instant status indication for food containment equipment as recited in claim 2, and wherein said threshold means further comprises a computer having a plurality of pre-set limits for characterizing said imminent unsafe food safety condition.

4. The automated system for giving an instant status indication for food containment equipment as recited in claim 3 wherein said pre-set limits include at least one of rate change data, and equipment failure data.

5. A process for giving an instant status indication for food containment equipment comprising:
sensing a current condition of said food containment equipment;
utilizing a pre-set characteristic to characterize said current condition into at least a normal operation condition, a non-food safety condition, an imminent unsafe food safety condition, and an unsafe food safety condition; and
activating an indicator to give an instant condition of said food containment equipment based upon said pre-set limit.

6. The process for giving an instant status indication for food containment equipment as recited in claim 5 wherein said activating an indicator step is accomplished by activating a light indicator.

7. The process for giving an instant status indication for food containment equipment as recited in claim 5 wherein said activating an indicator step is accomplished by activating an alphanumeric indicator.

8. The process for giving an instant status indication for food containment equipment as recited in claim 5 wherein said activating an indicator step is accomplished by automatically notifying a remote location by at least one of dialing a telephone line and connecting to a world wide computer network.

9. The process for giving an instant status indication for food containment equipment as recited in claim 5 and further comprising the step of disabling said food containment equipment after detecting an unsafe food safety condition.
